(19) United States
(12) Patent Application Publication
(10) Pub. No.: US 2026/0204596 A1
(43) Pub. Date: Jul. 16, 2026

(54) FUEL CELL

(71) Applicant: SUBARU CORPORATION, Tokyo (JP)

(72) Inventors: Keiko NAGANUMA, Tokyo (JP); Takumi NUNOKAWA, Tokyo (JP)

(21) Appl. No.: 19/436,895

(22) Filed: Dec. 30, 2025

(30) Foreign Application Priority Data
Jan. 10, 2025 (JP) 2025-004098

(51) Int. Cl. H01M 8/0254; H01M 8/026; H01M 8/0267; H01M 8/1004

(52) U.S. Cl. CPC H01M 8/0254; H01M 8/026; H01M 8/0267; H01M 8/1004; H01M 2250/20

(57) ABSTRACT

A fuel cell at least includes a first separator, a second separator, and a membrane electrode assembly. The first separator includes a corrugated structure configured to define a gas flow channel adjacent to the membrane electrode assembly and a cooling-water flow channel adjacent to the second separator. The gas flow channel and the cooling-water flow channel are alternately arranged. The corrugated structure includes corners. The gas flow channel and the cooling-water flow channel are partitioned from each other by a partition wall including a protruding portion protruding toward the gas flow channel from a reference line connecting a first corner vertex of one of the corners that is adjacent to the membrane electrode assembly and a second corner vertex of another one of the corners that is adjacent to the second separator. The protruding portion includes a third corner vertex.

### CROSS-REFERENCE TO RELATED APPLICATIONS

The present application claims priority from Japanese Patent Application No. 2025-004098 filed on January 10, 2025, the entire contents of which are hereby incorporated by reference.

### BACKGROUND

The disclosure relates to a fuel cell.

A known fuel cell includes a flow-channel separator configured to define gas flow channels and cooling-water flow channels.

For example, Japanese Unexamined Patent Application Publication (JP-A) No. 2009-016110 describes a separator for a fuel cell. The separator includes groove-shaped reactant-gas flow channels, through which reactant gas flows, on a surface facing a membrane electrode assembly; communication channels, through which adjacent ones of the reactant-gas flow channels communicate with each other, on the surface facing the membrane electrode assembly; and groove-shaped channels, constituting portions of cooling-water flow channels and extending parallel to the reactant-gas flow channels, on a surface opposite to the surface facing the membrane electrode assembly.

### SUMMARY

An aspect of the disclosure provides a fuel cell at least including a first separator, a second separator, and a membrane electrode assembly. The first separator includes a corrugated structure configured to define a gas flow channel adjacent to the membrane electrode assembly and a cooling-water flow channel adjacent to the second separator. The gas flow channel and the cooling-water flow channel are alternately arranged. The corrugated structure includes corners. The gas flow channel and the cooling-water flow channel are partitioned from each other by a partition wall including a protruding portion protruding toward the gas flow channel from a reference line connecting a first corner vertex of one of the corners that is adjacent to the membrane electrode assembly and a second corner vertex of another one of the corners that is adjacent to the second separator. The protruding portion includes a third corner vertex.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic diagram illustrating a vehicle including a fuel cell according to an embodiment of the disclosure;

FIG. 2 is an exploded perspective view illustrating the schematic configuration of the fuel cell according to the embodiment of the disclosure;

FIG. 3 is a schematic sectional view of a flow-channel separator included in the fuel cell according to the embodiment of the disclosure;

FIG. 4 is a sectional view of a flow-channel separator included in a fuel cell according to an of the disclosure; and

FIG. 5 is a sectional view of a flow-channel separator included in a fuel cell according to an embodiment of the disclosure.

### DETAILED DESCRIPTION

According to the technology of the related art described in JP-A No. 2009-016110, two adjacent flow-channel separators are stacked together such that cooling-water flow channels provided on the flow-channel separators face each other. Thus, the cross-sectional area of the cooling-water flow channels is increased. Accordingly, the pressure loss in cooling water can be somewhat reduced even when the cooling water flows at a higher flow rate and has a higher viscosity than reactant gas.

To reduce the manufacturing cost of a fuel cell, one of the two flow-channel separators may be replaced by a flat separator, and the other may be provided as a flow-channel separator. However, in such a fuel cell, it is difficult to increase the cross-sectional area of the cooling-water flow channels as in the technology of the related art while maintaining the thickness of the fuel cell. Additionally, when the cross-sectional area of the cooling-water flow channels is increased while the contact area between the flow-channel separator and the membrane electrode assembly is reduced, the contact resistance is increased.

It is desirable to provide a fuel cell in which the area of contact with the membrane electrode assembly is maintained roughly equal to or less than that in the related art, and in which the cross-sectional area of the cooling-water flow channels is increased to reduce the pressure loss.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### Overall Structure of Vehicle

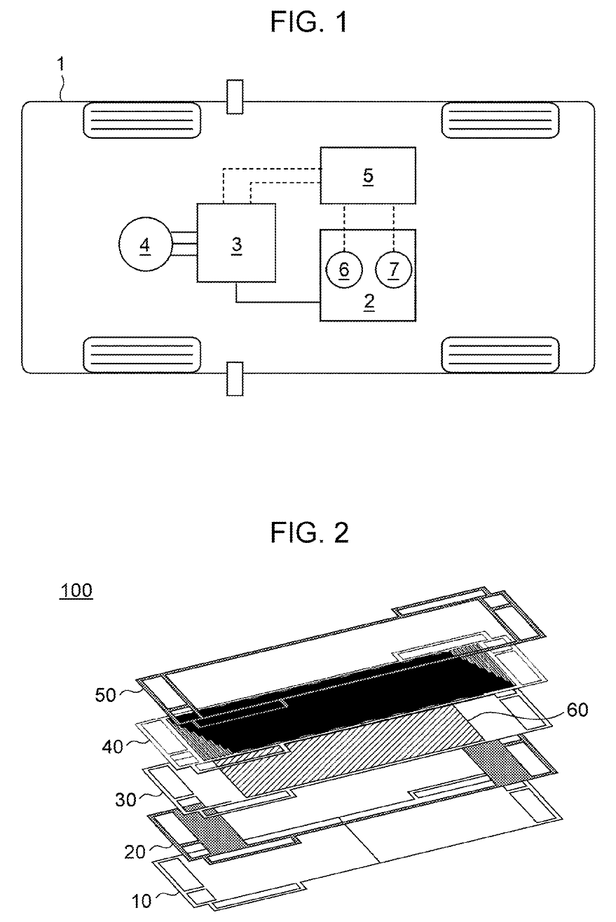

Referring to FIG. 1, a vehicle 1 according to an embodiment of the disclosure at least includes a fuel cell stack 2, an inverter 3, a load 4, and a controller 5. In the vehicle 1, electric power generated by the fuel cell stack 2 is supplied to the load 4 through the inverter 3 under the control of the controller 5. The vehicle 1 includes, for example, known components (not illustrated) of a fuel cell vehicle, such as a hydrogen tank, an anode gas supplier, a cathode gas supplier, a coolant supplier, and a DC/DC converter.

The fuel cell stack 2 includes tens to hundreds of fuel cells 100 described below stacked in a stacking direction.

Each fuel cell 100 serves to generate electricity by causing anode gas and cathode gas to react. The fuel cell stack 2 may include a known voltage sensor 6 capable of measuring, for example, a voltage applied to each fuel cell 100. The fuel cell stack 2 may also include a known current sensor 7 capable of measuring a current that flows through each fuel cell 100. There is no particular limitation regarding the fuel cells 100, and the fuel cells 100 may be, for example, known polymer electrolyte fuel cells (PEFCs).

The inverter 3 has a function of converting direct-current power boosted by, for example, a DC/DC converter into alternating-current power suitable for driving the load 4. There is no particular limitation regarding the inverter 3 as long as the above-described function is provided. For example, a known inverter including a three-phase bridge circuit may be used.

The load 4 includes, for example, a known electric motor capable of outputting power for driving drive wheels of the vehicle 1. The electric motor is, for example, a known three-phase alternating-current electric motor. The load 4 may be another electric device mounted in the vehicle 1.

The controller 5 is a known electronic control unit (ECU) mounted in a fuel cell vehicle and includes one or more processors, such as central processing units (CPUs), and one or more memories, such as semiconductor memories, magnetic memories, or optical memories, communicatively coupled to the processors. The controller 5 may further include a known battery management unit (BMU) that monitors and controls the state of a battery. The controller 5 may be capable of communicating with another known ECU and various sensors (not illustrated) mounted in the vehicle 1.

### Overall Structure of Fuel Cell

The overall structure of the fuel cell 100 that may be included in the fuel cell stack 2 installed in the vehicle 1 will be briefly described with reference to FIG. 2. The fuel cell 100 is, for example, formed by repeatedly stacking a flat separator 10, a first gasket 20, a sub-gasket 30, a flow-channel separator 40, and a second gasket 50 in that order. The fuel cell 100 further includes a membrane electrode assembly 60 disposed between the flat separator 10 and the flow-channel separator 40. The flow-channel separator 40 is an example of a "first separator" according to the disclosure. The flat separator 10 is an example of a "second separator" according to the disclosure.

### 2-1. Flat Separator

Unlike the flow-channel separator 40, the flat separator 10 is a rectangular, flat separator having no flow channels. It is not necessary that the flat separator 10 be flat over the entire region thereof, and may be flat at least in a reactive area in contact with the membrane electrode assembly 60. One of anode gas and cathode gas (for example, cathode gas) flows along a side of the flat separator 10 that faces the membrane electrode assembly 60. The flat separator 10 has through holes for cooling-water manifolds and through holes for gas manifolds as appropriate.

The flat separator 10 may be, for example, a known metal separator made of aluminum, stainless steel, or titanium, or a known carbon separator made of a carbon-based material.

### 2-2. First Gasket

The first gasket 20 has an outer shape corresponding to that of the flat separator 10. The first gasket 20 has through holes for cooling-water manifolds and through holes for gas manifolds corresponding to those in the flat separator 10 as appropriate.

The first gasket 20 may be made of a sealing material, for example, a synthetic resin, such as polyethylene naphthalate (PEN), polyethylene terephthalate (PET), polyphenylene sulfide (PPS), or silicone resin.

### 2-3. Sub-gasket

The sub-gasket 30 has an outer shape corresponding to those of the flat separator 10 and the first gasket 20. The sub-gasket 30 has through holes for cooling-water manifolds and through holes for gas manifolds corresponding to those in the flat separator 10 and the first gasket 20 as appropriate. The sub-gasket 30 has an accommodation space in which the membrane electrode assembly 60 is disposed in a central area.

The sub-gasket 30 may be made of a sealing material, for example, a synthetic resin, such as polyethylene naphthalate (PEN), polyethylene terephthalate (PET), or polyphenylene sulfide (PPS).

### 2-4. Flow-Channel Separator

The flow-channel separator 40 has a corrugated structure that defines gas flow channels and cooling-water flow channels. The flow-channel separator 40 has a corrugated structure configured to define the gas flow channels on a side adjacent to the membrane electrode assembly 60 and the cooling-water flow channels on a side adjacent to the flat separator 10, the gas flow channels and the cooling-water flow channels being alternately arranged. The other of anode gas and cathode gas (for example, anode gas) flows along the side of the flow-channel separator 40 facing the membrane electrode assembly 60, and cooling water flows along the side of the flow-channel separator 40 opposite to the side facing the membrane electrode assembly 60.

The flow-channel separator 40 has through holes for cooling-water manifolds and through holes for gas manifolds corresponding to those in the flat separator 10, the first gasket 20, and the sub-gasket 30.

The flow-channel separator 40 may be, for example, a known metal separator made of aluminum, stainless steel, or titanium.

### 2-5. Second Gasket

The second gasket 50 has an outer shape corresponding to those of the flat separator 10, the first gasket 20, the sub-gasket 30, and the flow-channel separator 40. The second gasket 50 has through holes for cooling-water manifolds and through holes for gas manifolds corresponding to those in the flat separator 10, the first gasket 20, the sub-gasket 30, and the flow-channel separator 40 as appropriate.

The second gasket 50 may be made of a sealing material, for example, a synthetic resin, such as polyethylene naphthalate (PEN), polyethylene terephthalate (PET), polyphenylene sulfide (PPS), or silicone resin.

### 2-6. Membrane Electrode Assembly

The membrane electrode assembly 60 is placed in the accommodation space formed in the sub-gasket 30. The membrane electrode assembly 60 may be a known or any other membrane electrode assembly in which an electrolyte layer (not illustrated) is disposed between a pair of catalyst layers (not illustrated) and a pair of gas diffusion layers (not illustrated).

The overall structure of the fuel cell 100 that may be installed in the vehicle 1 according to the embodiment of the disclosure has been briefly described. However, the fuel cell 100 according to the embodiment of the disclosure is not limited to this, and may further include, for example, a known or any other gasket in addition to the first gasket 20 and the second gasket 50.

### 3-1. First Embodiment

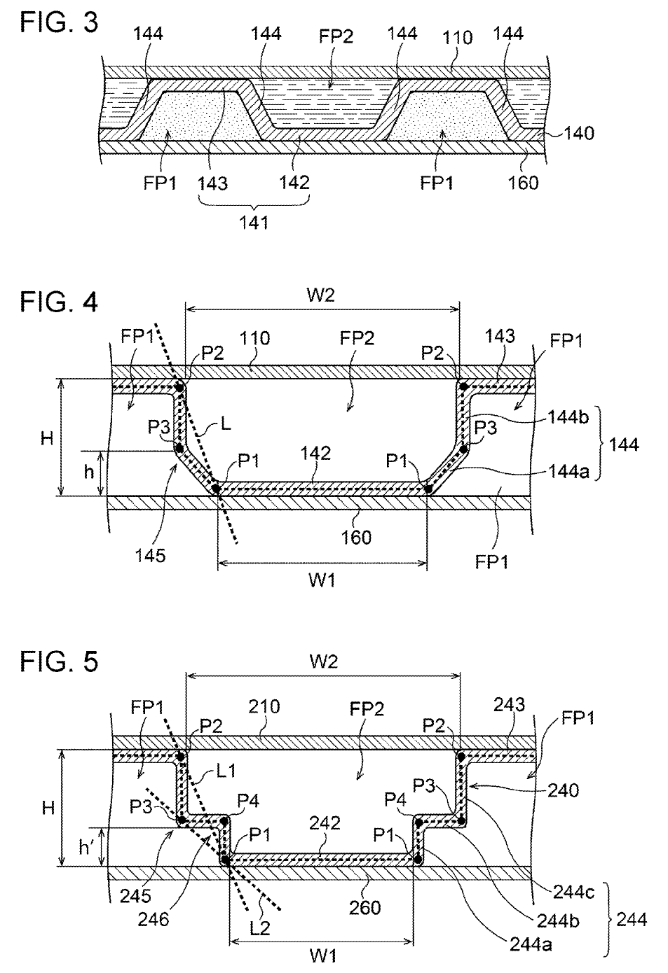

Referring to FIGS. 3 and 4, a flow-channel separator 140 capable of serving as the flow-channel separator 40 illustrated in FIG. 2 will now be described in detail as an example of the "first separator" in the fuel cell 100 according to a first embodiment.

As illustrated in FIG. 3, the fuel cell 100 has a multilayer structure in which at least a membrane electrode assembly 160, the flow-channel separator 140, and a flat separator 110 are repeatedly arranged in that order. In the sectional view of FIG. 3, another membrane electrode assembly 160 is stacked on a side of the flat separator 110 opposite to the side adjacent to the flow-channel separator 140.

The flow-channel separator 140 has a corrugated structure 141 configured to define gas flow channels FP1 on a side adjacent to the membrane electrode assembly 160, which is capable of serving as the membrane electrode assembly 60 illustrated in FIG. 2, and cooling-water flow channels FP2 on a side adjacent to the flat separator 110, which is capable of serving as the flat separator 10 illustrated in FIG. 2. The gas flow channels FP1 and the cooling-water flow channels FP2 are alternately arranged on the corrugated structure 141.

For example, the corrugated structure 141 of the flow-channel separator 140 includes groove portions 142 that are in contact with the membrane electrode assembly 160 on the side not in contact with the cooling-water flow channels FP2, ridge portions 143 that are in contact with the flat separator 110 on the side not in contact with the gas flow channels FP1, and partition walls 144 that couple the groove portions 142 to the ridge portions 143. The groove portions 142, the ridge portions 143, and the partition walls 144 form a repeating pattern in a direction crossing the direction in which the gas flow channels FP1 and the cooling-water flow channels FP2 extend. Thus, the gas flow channels FP1 are formed in sections surrounded by the ridge portions 143, the partition walls 144, and the membrane electrode assembly 160. The cooling-water flow channels FP2 are formed in sections surrounded by the groove portions 142, the partition walls 144, and the flat separator 110.

The partition walls 144 separate the gas flow channels FP1 and the cooling-water flow channels FP2 from each other. Note that FIG. 3 is intended to illustrate a schematic cross section of the flow-channel separator 140, and the partition walls 144 are simplified.

The gas flow channels FP1 may be either anode-gas flow channels or cathode-gas flow channels. The effect of the first embodiment is more significant when the gas flow channels FP1 are anode-gas flow channels.

Referring also to FIG. 4, the corrugated structure 141 including the groove portions 142 and the ridge portions 143 further includes multiple corners. The corners may include, for example, curved portions with a predetermined radius of curvature formed when the corrugated structure 141 is formed by a pressing process, such as a bending process. The number of circles of curvature that define the curved portions is not limited to one, and may be more than one. The corners according to the disclosure are not limited to this, and may have no radius of curvature as described above. For example, the corners may be portions formed of two flat surfaces.

Each partition wall 144 may include an inclined portion 144a coupled to a corresponding groove portion 142 and a standing wall portion 144b extending continuously from the inclined portion 144a and coupled to a corresponding ridge portion 143. In this case, a first corner vertex P1 adjacent to the membrane electrode assembly 160 is provided at the boundary between the inclined portion 144a and the groove portion 142. A second corner vertex P2 adjacent to the flat separator 110 is provided at the boundary between the standing wall portion 144b and the ridge portion 143. A third corner vertex P3 is provided at the boundary between the inclined portion 144a and the standing wall portion 144b.

When the above-described corners have radii of curvature, in the sectional view of FIG. 4, each of the first corner vertex P1, the second corner vertex P2, and the third corner vertex P3 may be an intersection between a tangent of a circle of curvature including a first end of a curved portion defining the corner at the first end and a tangent of a circle of curvature including a second end of the curved portion at the second end. In the example illustrated in FIG. 4, each corner vertex is defined as an intersection between:

a tangent of a circle of curvature including a first end of a curved portion defining the corner at the first end, the circle of curvature passing through the center of thickness of the flow-channel separator 140 at the first end; and

a tangent of a circle of curvature including a second end of the curved portion defining the corner at the second end, the circle of curvature passing through the center of thickness at the second end.

Note that each corner vertex may be within or outside the thickness of the flow-channel separator 140 depending on the radii of curvature of the circles of curvature.

When the above-described corners have no radii of curvature, in the sectional view of FIG. 4, the first corner vertex P1 may be an intersection between a straight line passing through the center of thickness of the groove portion 142 and the straight line passing through the center of thickness of the inclined portion 144a. The second corner vertex P2 may be an intersection between the straight line passing through the center of thickness of the ridge portion 143 and a straight line passing through the center of thickness of the standing wall portion 144b. The third corner vertex P3 may be an intersection between the straight line passing through the center of thickness of the inclined portion 144a and the straight line passing through the center of thickness of the standing wall portion 144b.

As described below, the technical concept according to the disclosure is to increase the cross-sectional area of each cooling-water flow channel FP2 by forming a protruding portion 145 that protrudes from the cooling-water flow channel FP2 toward a corresponding gas flow channel FP1.

Note that the definition of each corner vertex according to the disclosure is not limited to those described above as long as the technical concept of the disclosure can be realized.

A height h of the inclined portion 144a in the stacking direction of the fuel cell 100 may be greater than a compression thickness of the gas diffusion layer in the membrane electrode assembly 160. The height h may be, for example, 60 µm or more; however, the disclosure is not limited to this, and the height h may be determined as appropriate depending on the characteristics of the gas diffusion layer. The compression thickness is defined as a value obtained by subtracting the thickness of the gas diffusion layer compressed by the groove portion 142 from the original thickness of the gas diffusion layer.

The standing wall portion 144b is illustrated as being perpendicular or substantially perpendicular to the flat separator 110 in FIG. 4. However, the disclosure is not limited to this, and the standing wall portion 144b may be inclined toward the gas flow channel FP1 as appropriate.

Each partition wall 144 includes the protruding portion 145 that protrudes toward the gas flow channel FP1 from a reference line L connecting the first corner vertex P1 and the second corner vertex P2, and that includes the third corner vertex P3. Due to the protruding portion 145, the area of contact with the membrane electrode assembly 160 can be maintained roughly equal to or less than that in the related art, and the cross-sectional area of the cooling-water flow channel FP2 can be larger than that in the related art so that the cooling-water flow channel FP2 has a larger cross-sectional area than the gas flow channel FP1. Additionally, since the cross-sectional area of the cooling-water flow channel FP2 can be larger than that in the related art while the height of the fuel cell 100 in the stacking direction is roughly equal to that in the related art, a small fuel cell 100 can be obtained.

For example, the cooling-water flow channel FP2 may have a width W1 of 0.8 mm on a side adjacent to the membrane electrode assembly 160 and a width W2 of 1.09 mm on a side adjacent to the flat separator 110, and the flow-channel separator 140 may have a height H of 0.35 mm (including the material plate thickness 0.1 mm) in the stacking direction while the cooling-water flow channel FP2 has a cross-sectional area larger than that in the related art. The dimensions of the flow-channel separator 140 are not limited to those described above.

As described above, the flow-channel separator 140 included in the fuel cell 100 according to the first embodiment includes the corrugated structure 141 configured to define the gas flow channels FP1 adjacent to the membrane electrode assembly 160 and the cooling-water flow channels FP2 adjacent to the flat separator 110, the gas flow channels FP1 and the cooling-water flow channels FP2 being alternately arranged. In particular, the corrugated structure 141 includes multiple corners. Each gas flow channel FP1 and the cooling-water flow channel FP2 adjacent thereto are partitioned from each other by the partition wall 144 including the protruding portion 145 protruding toward the gas flow channel FP1 from the reference line L connecting the first corner vertex P1 of one of the corners that is adjacent to the membrane electrode assembly 160 and the second corner vertex P2 of another one of the corners that is adjacent to the flat separator 110. The protruding portion 145 includes the third corner vertex P3.

The effect of the first embodiment is significant when, for example, the flat separator 110 is used as the "first separator" and the flow-channel separator 140 as the "second separator" to reduce the manufacturing cost of the fuel cell 100. The flow-channel separator 140 includes the partition walls 144, each of which partitions the gas flow channel FP1 and the cooling-water flow channel FP2 from each other and includes the protruding portion 145 protruding toward the corresponding gas flow channel FP1. Thus, the area of contact with the membrane electrode assembly 160 can be maintained roughly equal to or less than that in the related art, and the cross-sectional area of the cooling-water flow channel FP2 can be increased to reduce the pressure loss.

The partition walls 144 according to the first embodiment are easy to process because the structure thereof is less complex than the structure of partition walls 244 according to a second embodiment described below. This enables a reduction in the manufacturing cost of the flow-channel separator 140, which in turn enables a reduction in the manufacturing cost of the fuel cell 100.

### 3-2. Second Embodiment

Referring to FIG. 5, a flow-channel separator 240 capable of serving as the flow-channel separator 40 illustrated in FIG. 2 will now be described in detail as an example of the "first separator" in the fuel cell 100 according to a second embodiment.

The flow-channel separator 240 has a corrugated structure including groove portions 242 and ridge portions 243 configured to define gas flow channels FP1 on a side adjacent to a membrane electrode assembly 260, which is capable of serving as the membrane electrode assembly 60 illustrated in FIG. 2, and cooling-water flow channels FP2 on a side adjacent to a flat separator 210, which is capable of serving as the flat separator 10 illustrated in FIG. 2. The gas flow channels FP1 and the cooling-water flow channels FP2 are alternately arranged.

The details of the corrugated structure are the same as those of the corrugated structure 141 according to the first embodiment; thus, the description of the first embodiment applies. Similarly to the first embodiment, the gas flow channels FP1 may be either anode-gas flow channels or cathode-gas flow channels. The effect of the second embodiment is more significant when the gas flow channels FP1 are anode-gas flow channels.

The corrugated structure including the groove portions 242 and the ridge portions 243 include multiple corners. The gas flow channels FP1 and the cooling-water flow channels FP2 are partitioned from each other by partition walls 244, each of which includes a protruding portion 245 protruding toward the gas flow channel FP1 from a reference line L1 connecting a first corner vertex P1 of one of the corners that is adjacent to the membrane electrode assembly 260 and a second corner vertex P2 of another one of the corners that is adjacent to the flat separator 210. The protruding portion 245 includes a third corner vertex P3. The flow-channel separator 240 also includes a diffusing portion 246 between the protruding portion 245 and the membrane electrode assembly 260 in the gas flow channel FP1. The diffusing portion 246 is configured to cause the gas passing through the gas flow channel FP1 to be diffused toward the membrane electrode assembly 260. The diffusing portion 246 may include a corner having a fourth corner vertex P4 on a side toward the cooling-water flow channel FP2 relative to a reference line L2 connecting the first corner vertex P1 and the third corner vertex P3. The definition of each corner vertex is the same as that in the first embodiment; thus, the description of the first embodiment applies.

Each partition wall 244 may include a first standing wall portion 244a, a flat portion 244b, and a second standing wall portion 244c. In this case, the first standing wall portion 244a is coupled to the groove portion 242. The flat portion 244b extends continuously from the first standing wall portion 244a along the cooling-water flow channel FP2 in a direction from the cooling-water flow channel FP2 toward the gas flow channel FP1. The second standing wall portion 244c extends continuously from the flat portion 244b and is coupled to the ridge portion 243.

The first corner vertex P1 adjacent to the membrane electrode assembly 260 is provided at the boundary between the groove portion 242 and the first standing wall portion 244a. The second corner vertex P2 adjacent to the flat separator 210 is provided at the boundary between the second standing wall portion 244c and the ridge portion 243. The third corner vertex P3 is provided at the boundary between the flat portion 244b and the second standing wall portion 244c. The fourth corner vertex P4 is provided at the boundary between the first standing wall portion 244a and the flat portion 244b.

The first standing wall portion 244a and the second standing wall portion 244c are illustrated as being perpendicular or substantially perpendicular to the membrane electrode assembly 260 and the flat separator 210 in FIG. 5. However, the disclosure is not limited to this, and the first standing wall portion 244a and the second standing wall portion 244c may be inclined in a direction from the cooling-water flow channel FP2 toward the gas flow channel FP1 as appropriate. Similarly, the flat portion 244b is illustrated as being perpendicular or substantially perpendicular to the first standing wall portion 244a and the second standing wall portion 244c in FIG. 5. However, the disclosure is not limited to this, and the flat portion 244b may be inclined toward the membrane electrode assembly 160 or the flat separator 10 as appropriate.

When each partition wall 244 includes the first standing wall portion 244a, the flat portion 244b, and the second standing wall portion 244c, the protruding portion 245 may at least include a region surrounded by the above-described reference line L1, the second standing wall portion 244c, and the flat portion 244b in the sectional view of FIG. 5. Due to the protruding portion 245, the area of contact with the membrane electrode assembly 260 can be maintained roughly equal to or less than that in the related art, and the cross-sectional area of the cooling-water flow channel FP2 can be somewhat larger than that in the related art so that the cooling-water flow channel FP2 has a larger cross-sectional area than the gas flow channel FP1.

Additionally, when each partition wall 244 includes the first standing wall portion 244a, the flat portion 244b, and the second standing wall portion 244c, the diffusing portion 246 may at least include a region surrounded by the above-described reference line L2, the first standing wall portion 244a, and the flat portion 244b in the sectional view of FIG. 5.

The gas diffusion layer (not illustrated) included in the membrane electrode assembly 260 is typically a sponge material, and therefore may be deformed by a surface pressure applied by the flow-channel separator 240. However, according to the second embodiment, even when the gas diffusion layer (not illustrated) included in the membrane electrode assembly 260 is deformed, a region for causing the gas passing through the gas flow channel FP1 to be diffused toward the membrane electrode assembly 260 can be provided between the protruding portion 245 and the membrane electrode assembly 260 (near the contact position between the first standing wall portion 244a and the membrane electrode assembly 260) in the gas flow channel FP1.

A height h' of the first standing wall portion 244a in the stacking direction of the fuel cell 100 may be greater than a compression thickness of the gas diffusion layer in the membrane electrode assembly 260. The height h' may be, for example, 60 µm or more; however, the disclosure is not limited to this, and the height h' may be determined as appropriate depending on the characteristics of the gas diffusion layer. The compression thickness is defined as a value obtained by subtracting the thickness of the gas diffusion layer compressed by the groove portion 242 from the original thickness of the gas diffusion layer.

Similarly to the first embodiment, in the sectional view of FIG. 5, the cooling-water flow channel FP2 may have a width W1 of 0.8 mm on a side adjacent to the membrane electrode assembly 260, a width W2 of 1.09 mm on a side adjacent to the flat separator 210, and a height H of 0.35 mm (including the material plate thickness 0.1 mm) in the stacking direction. The dimensions of the flow-channel separator 240 are not limited to those described above.

As described above, in addition to the features of the first embodiment, the flow-channel separator 240 included in the fuel cell 100 according to the second embodiment includes the diffusing portion 246 between the protruding portion 245 and the membrane electrode assembly 260 in the gas flow channel FP1. The diffusing portion 246 is configured to cause the gas passing through the gas flow channel FP1 to be diffused toward the membrane electrode assembly 260.

According to the second embodiment, the diffusing portion 246 provides a region in which gas can be diffused between the membrane electrode assembly 260 and the partition wall 244, so that a reduction in the pressure loss is less likely to occur. Also in the second embodiment, due to the protruding portion 245, the area of contact with the membrane electrode assembly 260 can be maintained roughly equal to or less than that in the related art, and the cross-sectional area of the cooling-water flow channel FP2 can be somewhat larger than that in the related art so that the cooling-water flow channel FP2 has a larger cross-sectional area than the gas flow channel FP1.

Although embodiments of the disclosure have been described in detail above with reference to the drawings, the disclosure is not limited to these examples. It is obvious that a person having ordinary knowledge in the technical field to which the disclosure pertains can arrive at various alterations and modifications within the scope of the technical idea described in the claims, and it is to be understood that such alterations and modifications also belong to the technical scope of the disclosure. For example, functions or the like included in components, steps, or the like may be rearranged without any logical inconsistencies, and the components, steps, or the like may be combined together or divided.

The technology of the disclosure may be implemented as a vehicle 1 including the fuel cell 100 according to the above-described embodiments.

According to an embodiment of the disclosure, the area of contact with a membrane electrode assembly in a fuel cell can be maintained roughly equal to or less than that in the related art, and the cross-sectional area of a cooling-water flow channel can be increased to reduce the pressure loss.

1. A fuel cell at least comprising:
a first separator;
a second separator; and
a membrane electrode assembly,
wherein the first separator comprises a corrugated structure configured to define a gas flow channel adjacent to the membrane electrode assembly and a cooling-water flow channel adjacent to the second separator, the gas flow channel and the cooling-water flow channel being alternately arranged,
wherein the corrugated structure comprises corners, and
wherein the gas flow channel and the cooling-water flow channel are partitioned from each other by a partition wall comprising a protruding portion protruding toward the gas flow channel from a reference line connecting a first corner vertex of one of the corners that is adjacent to the membrane electrode assembly and a second corner vertex of another one of the corners that is adjacent to the second separator, the protruding portion comprising a third corner vertex.

2. The fuel cell according to claim 1, wherein the cooling-water flow channel has a cross-sectional area larger than a cross-sectional area of the gas flow channel.

3. The fuel cell according to claim 1, wherein the first separator further comprises a diffusing portion between the protruding portion and the membrane electrode assembly in the gas flow channel, the diffusing portion being configured to cause gas passing through the gas flow channel to be diffused toward the membrane electrode assembly.

4. The fuel cell according to claim 2, wherein the first separator further comprises a diffusing portion between the protruding portion and the membrane electrode assembly in the gas flow channel, the diffusing portion being configured to cause gas passing through the gas flow channel to be diffused toward the membrane electrode assembly.

5. The fuel cell according to claim 3, wherein the diffusing portion comprises a corner having a fourth corner vertex on a side toward the cooling-water flow channel relative to a reference line connecting the first corner vertex and the third corner vertex.

6. The fuel cell according to claim 4, wherein the diffusing portion comprises a corner having a fourth corner vertex on a side toward the cooling-water flow channel relative to a reference line connecting the first corner vertex and the third corner vertex.
